(19) United States
(12) Patent Application Publication
(10) Pub. No.: US 2007/0228625 A1
(43) Pub. Date: Oct. 4, 2007

(54) HELICAL COMPRESSION SPRING

(75) Inventors: Hans-Ulrich Kriese, Weissensee (DE); Boris Ditzer, Kirchhundem (DE); Jochen Asbeck, Attendorn (DE); Jorg Neubrand, Freudenberg (DE)

Correspondence Address: ROBERTS, MLOTKOWSKI & HOBBES, P. O. BOX 10064, MCLEAN, VA, 22102-8064, US

(73) Assignee: MUHR UND BENDER KG, Attendorn (DE)

(21) Appl. No.: 11/693,196

(22) Filed: Mar. 29, 2007

(30) Foreign Application Priority Data
Mar. 30, 2006 (DE) 10 2006 015 216.6

(51) Int. Cl. F16F 1/12; F16F 1/06

(52) U.S. Cl. 267/179

(57) ABSTRACT

A helical compression spring (3) with two end turns (7) and a transition area adjoining each end turn (7) as an axle spring for wheel suspensions of motor vehicles, for example, for wheel suspensions with a wheel-guiding MacPherson strut unit (5) which has a helical compression spring (3) and a shock absorber (4), and which is connected, on the one hand, to the body (1), and on the other hand, to the wheel (2), and with a suspension arm (6). The helical compression spring (3) has its vibration strength and the service life greatly increased by the end turns (7) and/or transition regions being machined by worked hardening by rolling and/or by work hardening by hammering.

### BACKGROUND OF THE INVENTION

1. Field of the Invention

The invention relates to a helical compression spring with two end turns and one transition area adjoining each end turn as an axle spring for wheel suspensions of motor vehicles, for example for wheel suspensions with a wheel-guiding MacPherson strut unit which has a helical compression support spring and a shock absorber, and which is connected, on the one hand, to the body, and on the other hand, to the wheel, and with a suspension arm.

2. Description of Related Art

In motor vehicles, springs, especially steel springs, are extensively used, specifically in the region of the drive, the chassis as well as the body and function actuations. Here, they are springs in the region of the chassis, specifically helical compression springs as axle springs for the wheel suspensions which belong to chassis.

For the operation and importance of the chassis of motor vehicles, especially also the wheel suspensions and the helical compression springs which belong to them as axle springs, reference is made, among others, to LUEGER ENGINEERING LEXICON, Volume 12 AUTOMOTIVE ENGINEERING LEXICON, 1997, Deutsche Verlags-Anstalt GmbH, Stuttgart, especially, page 198, right column, page 203, right column, bottom, page 204, left column, to Chassis Engineering 1 by Cert. Eng. Joemsen Reimpell, 1970, Vogel-Verlag, Wuerzburg, especially to pages 78 to 145, to BOSCH Automotive Engineering Handbook, 25th edition, 2003, Friedr. Vieweg & Sohn Verlag/GWV Fachverlage GmbH, Wiesbaden, especially to pages 754 to 767, and quite especially to Steel Spring Elements for the Automobile Industry by Ludwig M. Leiseder, The Library of Engineering, volume 140, 1997. Verlag Moderne Industry, Landsberg, especially there, to pages 7 to 20 and 46 to 54. The disclosure contents of these documents which had been published previously as technical knowledge are hereby made expressly incorporated by reference for explanation of type of helical compression springs under discussion.

One special problem in wheel suspensions with a wheel-guiding MacPherson strut unit, which has a helical compression support spring and a shock absorber, and which is connected, on the one hand, to the body, and on the other hand, to the wheel, and with a suspension arm, is transverse force compensation. One trailblazing development has already been completed in this respect (see, German patent 37 43 450, European patent 0 319 651 and U.S. Pat. No. 4,903,985 with the same contents, German patent 101 25 503 and corresponding U.S. Pat. No. 6,808,193, and citation Steel Spring Elements for the Automobile Industry, pages 50 and 51, FIG. 34: MacPherson strut unit with SL springs); in this connection, it is a helical compression spring with a spring center line in the unloaded state running in a S shape, and in the working region, again, assuming a roughly cylindrical shape. Its transverse force-compensating action results from the fact that it has a line of force action which runs obliquely to the spring axis, and thus, provides for considerable reduction of the transverse force on the shock absorber rod when the helical compression spring is inclined only moderately relative to the shock absorber axis. In by far most motor vehicles which have MacPherson strut units, the above described so-called SL springs are used at present.

As follows especially from the publication Steel Spring Elements for the Automobile Industry, especially from the statements on pages 7 to 20 and 46 to 54, helical compression springs must satisfy the especially high requirements under consideration here, especially with respect to limited creep or relaxation tendency and prescribed vibration strength, and there are a host of influencing parameters to meet these requirements. The given objective of weight optimization is of considerable importance here. For almost a decade, wires which had been used for years with tensile strengths from 1650 MPa to 1850 MPa have been being replaced by high strength wires with tensile strengths of 1900 MPa to 2050 MPa. Currently, high-strength wires with tensile strengths of 2200 MPa and more are being used.

In the known helical compression springs of the type under consideration, of course, a plurality of influencing parameters are considered and measures are taken with the object of meeting the requirements imposed on these helical compression springs, especially also a given vibration strength and the thus required service life—especially important for the chassis of motor vehicles. For these influencing parameters and measures—among other factors, tensile strength, yield strength, hardness and ductility, behavior of inherent stresses, material structure, degree of purity, surface quality, use of patented, drawn wire, oil tempered wire, wire from hard-drawn carbon steels or from high alloy steels, heat treatment, ageing, strain hardening, shot peening, surface protection by powder coating or immersion enameling and facings—reference is made again to the citation Steel Spring Elements for the Automobile Industry, pages 7 to 20 and 46 to 54.

### SUMMARY OF THE INVENTION

En route to the invention, it was recognized that, in spite of the host of influencing parameters which were taken into account and the host of measures implemented with the objective of satisfying the requirements imposed on the helical compression springs under consideration, in individual cases, the given vibration strength, and thus, the required service life are not achieved. Specifically, it was found that breaks occur in the region of the end turns, with which the helical compression springs are conventionally clamped between spring disks, and/or in the transition regions. Consequently, a primary object of the invention is to improve the known helical compression springs underlying the invention, with respect to vibration strength and thus service life.

The helical compression spring in accordance with the invention, which is characterized by further improved vibration strength and thus further increased service life as compared to known helical compression springs, first of all, is characterized essentially in that the end turns and/or transition regions are worked additionally by work hardening by rolling and/or by work hardening by hammering. Hereinafter, work hardening by rolling is defined in a narrower sense and also in a wider sense; work hardening by hammering will also be defined hereinafter as work hardening by rolling.

Work hardening by rolling is a machining process (compare LUEGER ENGINEERING LEXICON, volume 8, LEXICON OF PRODUCTION ENGINEERING AND MACHINERY, 1997, Deutsche Verlags-Anstalt GmbH, Stuttgart, page 246, right column) by which the strength of the material in the outside layers can be increased. Besides hardening the material by roughly 30% of its initial strength, compression pre-stressing systems are formed which greatly increase the fatigue strength, specifically the cyclic bending strength, and what is especially important here, the vibration strength. (Regarding work hardening by rolling, refer also to the citation Mechanical Surface Treatment, published by Erhard Broszeit, 1989, Verlag DGM-Informationsgesellschaft, Oberursel.)

It has already been mentioned that it was recognized en route to the invention that, for helical compression springs belonging to the prior art, in individual cases, the given vibration strength and thus also the required service life are not reached, so that breaks occur in the region of the end turns with which the helical compression springs are conventionally clamped between spring plates. Consequently, one teaching which defines the general teaching of the invention is to machine the end turns in the roll-down region with the spring plates and to machine the end turns in the roll-down regions with the spring plates by work hardening by rolling for a helical compression spring as an axle spring for a wheel suspension to which at least one spring plate, generally two spring plates. There are wheel suspensions or wheel suspensions are possible which include only one spring plate. Generally, however, the wheel suspensions under consideration include two spring plates. Consequently, it is always assumed below that the helical compression spring in accordance with the invention is intended as an axle spring for a wheel suspension which includes two spring plates.

The contact of the end turns of a helical compression spring with the spring plates of the wheel suspension is not static; static here means that between the contact points, the contact lines or the contact surfaces of the end turns of the helical compression springs and the spring plates, no relative movements occur. However, in fact, the contacts of the contact points, the contact lines or the contact surfaces of the end turns of the helical compression springs with the spring plates are dynamic; here dynamic means that between the contacts of the contact points, contact lines or contact surfaces of the end turns of the helical compression springs with the disk springs, relative motions occur. The contact of the contact points, the contact lines or the contact surfaces of the end turns of the helical compression springs therefore “migrate” with respect to the contact points, the contact lines or the contact surfaces of the spring plates. This applies especially, but not solely, in the so-called SL springs described above. This results in that there are roll-down regions both on the end turns of the helical compression springs and also on the spring plates. For the above defined teaching in accordance with the invention, it is the roll-down regions of the contact points, the contact lines or the contact surfaces of the end turns of the helical compression springs that are involved.

With consideration of what was stated above, it could be theoretically sufficient to machine the end turns of the helical compression springs only in the explained roll-down regions with the spring plates by work hardening by rolling. However, this is not feasible. On the one hand, the roll-down regions under consideration cannot be exactly established; the roll-down region can also “migrate”, for example, depending on the specific installation of the wheel suspension in the motor vehicle or on the specific installation of the helical compression springs in the wheel suspension. On the other hand, for safety reasons, it is recommended that the end turns of the helical compression springs also be machined in the regions bordering the roll-down regions with the spring plates by work hardening by rolling, preferably machined in all regions bordering the roll-down regions with the spring plates by work hardening by rolling. The size of the regions which border the roll-down regions of the end turns and which also are machined by work hardening by rolling will be empirically established by one skilled in the art. The impetus for this can be the stipulation that the regions which border the roll-down regions of the end turns and which are also machined by work hardening by rolling, have roughly 0.2 to 2-fold extension as the roll-down regions, viewed from the theoretical center point of the roll-down regions, preferably 0.5 to 1-fold extension, especially roughly the same extension.

It was described above that the end turns of the helical compression springs in the roll-down region with the spring plates and the end turns in the roll-down regions with the spring plates are machined by work hardening by rolling. However, it is recommended that the helical compression springs in the entire region of the end turns and preferably also the transition regions be machined by work hardening by rolling, therefore not only in the roll-down region with the spring plates and in the roll-down regions with the spring plates. Work hardening of the end turns and preferably also the transition regions of the helical compression springs by rolling in accordance with the invention leads to optimum inherent compressive stresses in the regions which have been machined by work-hardening by rolling.

The subject matter of the invention is also a wheel suspension, especially a wheel suspension with a wheel-guiding MacPherson strut unit which has a helical compression support spring and a shock absorber, and which is connected, on the one hand, to the body, and on the other hand, to the wheel, with a suspension arm.

The subject matter of the invention is also a working process for machining of the end turns of a helical compression spring as an axle spring for wheel suspensions of motor vehicles, especially for wheel suspensions with a wheel-guiding MacPherson strut unit which has a helical compression support spring and a shock absorber, and which is connected on the one hand, to the body, and on the other hand, to the wheel, and with a suspension arm, characterized in that the end turns and/or the transition regions of the helical compression spring are additionally machined by work hardening by rolling and/or hammering. Reference is made to the statements above in conjunction with the helical compression spring for where additional machining takes place by the work hardening by rolling and/or hammering.

In the working process in accordance with the invention, it is possible to proceed as is known in the prior art for work hardening by rolling. With consideration of the special geometry of the regions to be worked, meandering tracing of these regions with a small path offset, therefore paths bordering on top of one another, preferably overlapping, is recommended. Otherwise, the regions to be machined can also be traced with a rotating, eccentric tool for work hardening by rolling. The regions to be machined can finally also be machined by a tool for work hardening by rolling which rotates around the corresponding regions, therefore around the end turns and preferably also around the transition regions of the helical compression springs.

Tests have shown that use of the invention, under corrosive conditions, leads to a considerable lengthening of service life of the helical compression springs under consideration, specifically to a service life which has been increased by a factor of 2.2 to 2.8.

In particular, there are a host of possibilities for embodying and developing the teaching of the invention. In this respect reference is made the following detailed explanation in conjunction with the accompanying drawings.

### BRIEF DESCRIPTION OF THE DRAWINGS

FIG. 1 shows a special embodiment of a wheel suspension of motor vehicles with a helical compression spring in accordance with the invention,

FIG. 2 is a top view of one part of the top end turn of the helical compression spring used in the wheel suspension in accordance with the invention on a scale greatly enlarged as compared to FIG. 1,

FIG. 3 shows a first type of work hardening by rolling for use in accordance with the invention,

FIG. 4 shows a second type of work hardening by rolling for use in accordance with the invention, and

FIG. 5 shows a third type of work hardening by rolling for use in accordance with the invention.

### DETAILED DESCRIPTION OF THE INVENTION

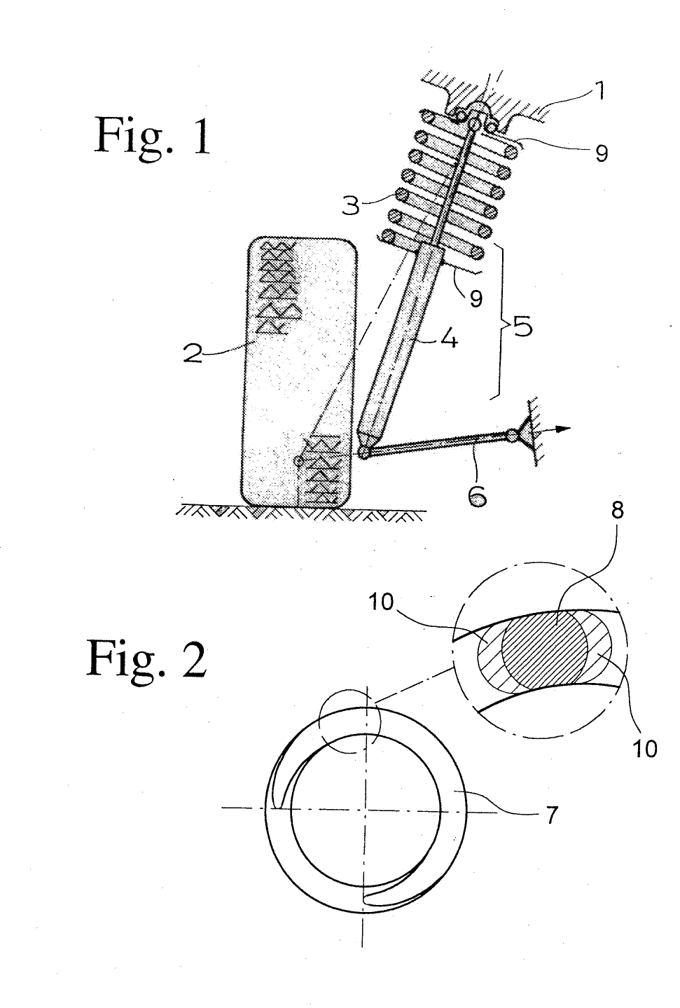

FIG. 1, which corresponds substantially to FIG. 1 of German Patent 37 43 450, European Patent 0 319 651 and U.S. Pat. No. 4,903,985 with the same content, shows a special wheel suspension of a motor vehicle, specifically a wheel suspension with a wheel-guiding MacPherson strut unit 5 which has a helical compression support spring 3 and a shock absorber 4, and which is connected, on the one hand, to the body 1, and on the other hand, to the wheel 2, and which also has a suspension arm 6.

FIG. 2 shows the teaching of the present invention which essentially involves, specifically, first of all, that the end turns 7 of the helical compression spring 3, in addition to the measures known in the prior art, are machined by work hardening by rolling. The enlarged extract of FIG. 2 shows that the end turn 7 of the helical compression spring 3, in the roll-down region shown by fine crosshatching is machined by work hardening by rolling. The roll-down region 8 of the end turn 7 of the helical compression spring 3 is the above explained region of the end turn 7 of the helical compression spring 3 which comes into contact with the spring plate 9 shown in FIG. 1, in the form of a spot, line or surface. Preferably, as is shown in the enlarged extract from FIG. 2, the end turns 7 of the helical compression spring 3 are also machined by work hardening by rolling in the regions 10 which are shown coarsely crosshatched and which border the roll-down regions, specifically in all the regions 10 bordering the roll-down regions 8.

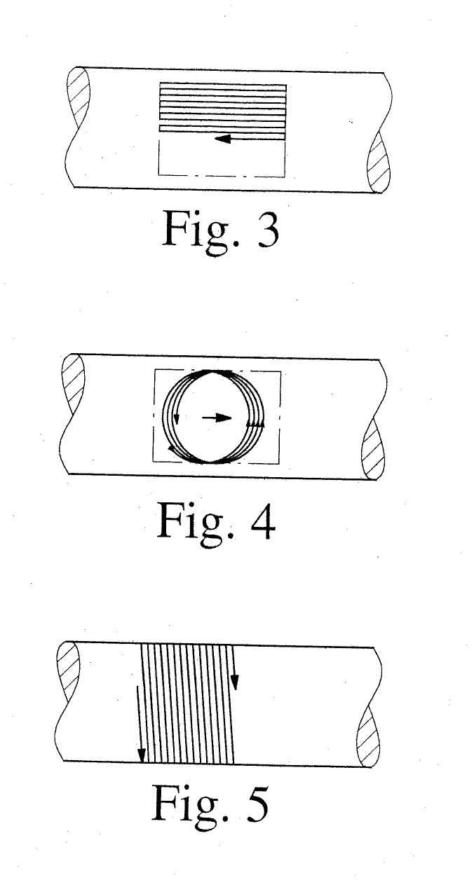

FIG. 3 shows a first type of work hardening by rolling to be used in accordance with the invention. The region to be machined with a tool for work hardening by rolling is traced in a meander, with a relatively small path offset so that paths bordering on top of one another, preferably overlapping, arise.

In the embodiment shown in FIG. 4, the regions to be machined are traced with a rotating, eccentric tool for work hardening by rolling. Here, it is also recommended that the process be carried out such that overlapping regions form.

The type of work hardening by rolling which is shown in FIG. 5 is especially suited when the end turns and preferably also the transition regions are machined altogether by work hardening by rolling, therefore, not only in the roll-down region by the spring plate or in the roll-down regions with the spring plates. This type of work hardening by rolling involves the entire jacket surface of the end turns, or of the end turns and the bordering transition regions, are machined by a tool for work hardening by rolling which rotates around the corresponding region or around the corresponding regions.

What is claimed is:

1. Helical compression spring formed as an axle support spring for a wheel suspension of a motor vehicles, the spring comprising a metal wire coil having an end turn at each end of the coil and a transition area adjoining each end turn, one of the end turns being adapted for connection to a motor vehicle body and the other end being adapted for connection to a wheel via a shock absorber, wherein at least one the end turns and the transition areas have been work hardened by at least one of rolling and hammering.

2. Helical compression spring in accordance with claim 1, wherein the end turns have a roll-down region for connection with a spring plate and wherein the end turns have been work-hardened by rolling in the roll-down regions.

3. Helical compression spring in accordance with claim 2, wherein the end turns have also been work-hardened by rolling in regions bordering the roll-down regions.

4. Helical compression spring in accordance with claim 3, wherein the end turns have been work-hardened by rolling in all regions bordering the roll-down regions.

5. Helical compression spring in accordance with claim 3, wherein the regions which border the roll-down regions of the end turns and which have been work-hardened by rolling have been extended roughly 0.2 to 2-fold viewed from a theoretical center point of the roll-down regions.

6. Helical compression spring in accordance with claim 3, wherein the regions which border the roll-down regions of the end turns and which have been work-hardened by rolling have been extended roughly 0.5 to 1-fold viewed from a theoretical center point of the roll-down regions.

7. Helical compression spring in accordance with claim 1, wherein the at least one of the end turns and transition areas have been work-hardened by rolling over an entire jacket surface thereof.

8. Wheel suspension of a motor vehicle which is adapted for connection to a motor vehicle body and to a wheel, comprising:
a helical compression support spring,
a shock absorber, and
a suspension arm,
wherein the helical compression spring is formed of a metal wire coil having an end turn at each end of the coil and a transition area adjoining each end turn,
wherein at least one the end turns and the transition areas have been work hardened by at least one of rolling and hammering.

9. Wheel suspension in accordance with claim 8, further comprising spring plates, wherein the end turns have a roll-down region for connection with a respective one of the spring plates and wherein the end turns have been work-hardened by rolling in the roll-down regions.

10. Wheel suspension in accordance with claim 8, wherein the end turns have also been work-hardened by rolling in regions bordering the roll-down regions.

11. Wheel suspension in accordance with claim 10, wherein the end turns have been work-hardened by rolling in all regions bordering the roll-down regions.

12. Wheel suspension in accordance with claim 10, wherein the regions which border the roll-down regions of the end turns and which have been work-hardened by rolling have been extended roughly 0.2 to 2-fold viewed from a theoretical center point of the roll-down regions.

13. Wheel suspension in accordance with claim 10, wherein the regions which border the roll-down regions of the end turns and which have been work-hardened by rolling have been extended roughly 0.5 to 1-fold viewed from a theoretical center point of the roll-down regions.

14. Wheel suspension in accordance with claim 8, wherein the at least one of the end turns and transition areas have been work-hardened by rolling over an entire jacket surface thereof.

15. Working process for machining of end turns of a helical compression support spring for an axle spring for wheel suspensions of motor vehicles, comprising the steps of:
providing a helical compression support spring formed of a metal wire coil having an end turn at each end of the coil and a transition area adjoining each end turn, and
work-hardening at least one of the end turns and the transition regions of the helical compression support spring at least one of rolling and hammering.

16. Working process in accordance with claim 15, wherein work-hardened step is performed by rolling a tool along a back-and-forth meandering path having a relatively small path offset.

17. Working process in accordance with claim 15, work-hardened step is performed by rolling with a rotating, eccentric tool.

18. Working process in accordance with claim 17, work-hardened step is performed along an overlapping path.

19. Working process in accordance with claim 8, wherein the entire jacket surface of the regions to be machined are work hardened by rolling with a tool for working hardening which rotates around at least one of the end turns and the transition regions of the helical compression support spring.
